(19) United States
(12) Patent Application Publication
(10) Pub. No.: US 2014/0032274 A1
(43) Pub. Date: Jan. 30, 2014

(54) APPARATUS, SYSTEM, AND METHOD FOR MANAGING DYNAMIC PRICING FOR ONLINE SALES

(71) Applicants: Todd Bradley Jensen, Herriman, UT (US); Kevin Alan Neilson, South Jordan, UT (US); Paul Lydolph, III, Eagle Mountain, UT (US)

(72) Inventors: Todd Bradley Jensen, Herriman, UT (US); Kevin Alan Neilson, South Jordan, UT (US); Paul Lydolph, III, Eagle Mountain, UT (US)

(73) Assignee: TIKR, INC., Draper, UT (US)

(21) Appl. No.: 13/562,172

(22) Filed: Jul. 30, 2012

(51) Int. Cl. G06Q 30/02

(52) U.S. Cl. 705/7.35

(57) ABSTRACT

A system for managing dynamic pricing for online sales. The system includes a server to operate a commerce manager, a commerce manager, and a client. The server includes a processing device and a memory. The commerce manager includes a dynamic price manager operating on the processing device of the server to dynamically generate a price for a product. The dynamic price manager is influenced by market cues. The price is generated at a predetermined time interval. The client interacts with the commerce manager and is in communication with the server via a network. The client displays the price.

### CROSS REFERENCE TO RELATED APPLICATIONS

Not applicable.

### BACKGROUND

The advent of the Internet has resulted in dramatic changes to many fields. Shopping, for example, has undergone a revolution in the Internet age. The volume of online sales has steadily increased as buyers and sellers have shifted their shopping to cyberspace.

To capitalize on these online sales, traditional methods of shopping have been applied to the internet. Regular, fixed-price sales and auctions have been adapted for use on the internet by companies such as Amazon and eBay. Other than being applied to the Internet, there is very little new about these types of sales methodologies.

As online shopping has evolved, consumers have been progressively fascinated by online fixed-price shopping and various types of auctions. As with many technologies, what was once a novelty has become commonplace. Consumers are more and more likely to demand shopping methods that leverage the available technology to meet their needs.

### BRIEF DESCRIPTION OF THE SEVERAL VIEWS OF THE DRAWINGS

FIG. 1 is a block diagram depicting one embodiment of a system for online shopping.

FIG. 2 is a block diagram depicting one embodiment of the commerce manager of FIG. 1.

FIG. 3 is a block diagram depicting one embodiment of the demand variable generator of FIG. 2.

FIG. 4 is a block diagram depicting one embodiment of the social reach tracker of FIG. 3.

FIG. 5 depicts one embodiment of the supply variable generator of FIG. 2.

FIG. 6 depicts one embodiment of a price history display.

FIG. 7 is a block diagram depicting one embodiment of the checkout manager of FIG. 2.

FIG. 8 depicts one embodiment of a seller queue.

FIG. 9 depicts a flowchart diagram showing one embodiment of a method for dynamically pricing a product.

FIG. 10 depicts a flowchart diagram showing one embodiment of a method for assigning a purchase to a seller.

FIG. 11 depicts a flowchart diagram showing one embodiment of a method for generating a demand variable.

FIG. 12 depicts a flowchart diagram showing one embodiment of a method for generating a supply variable.

FIG. 13 depicts a flowchart diagram showing one embodiment of a method for generating a social reach variable.

FIG. 14 depicts a flowchart diagram showing one embodiment of a method for reducing a price based on previous profits.

FIG. 15 depicts a flowchart diagram showing one embodiment of a method for managing a checkout process.

FIG. 16 is a block diagram depicting one embodiment of a computer system for facilitating the execution of the commerce manager of FIG. 1.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments provide a dynamic price for a product. The dynamic price may be calculated using market cues, such as parameters that indicate demand for the product and available supply for a product. Additional described embodiments may provide a checkout process that allows a buyer to temporarily lock a price for review for a predetermined period of time prior to committing to buy the product.

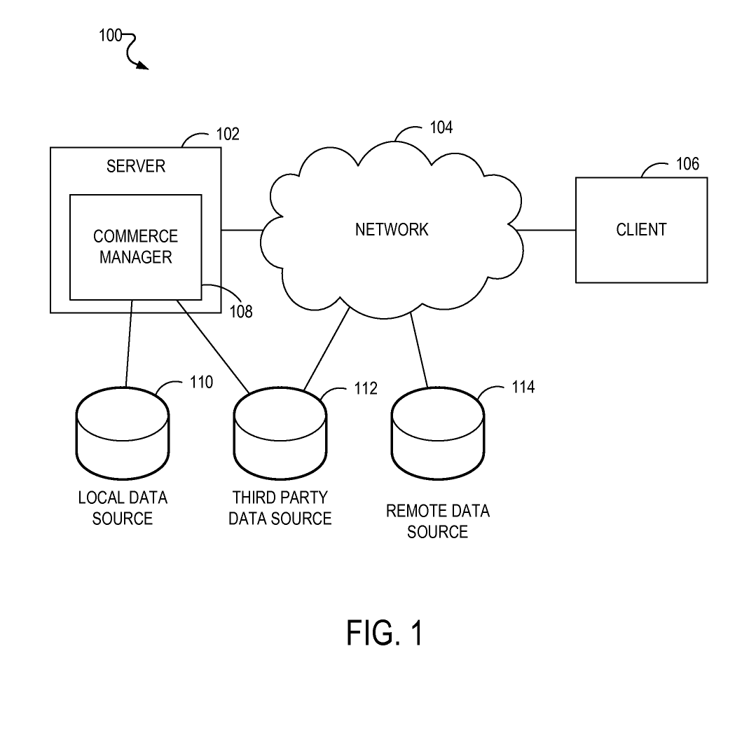

FIG. 1 is a block diagram depicting one embodiment of a system 100 for online shopping. The system 100 includes a server 102, a network 104, and a client 106. The system 100 provides a dynamic price for display on the client 106 and manages a sales process for the product.

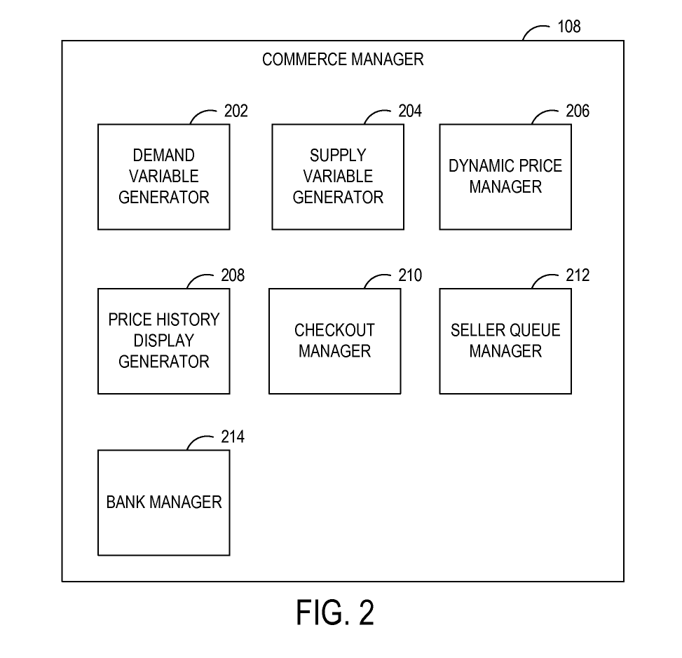

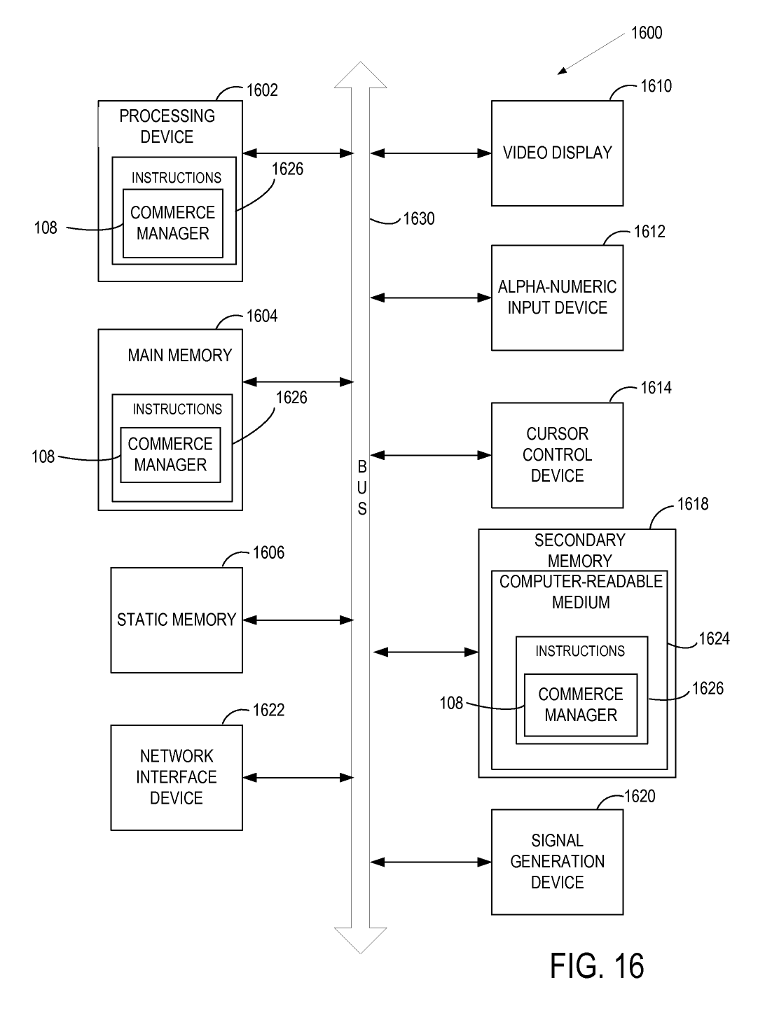

The server 102, in some embodiments, is a computing device that operates a commerce manager 108. The commerce manager 108 manages an online shopping application. An embodiment of the server 102 is described in greater detail in relation to FIG. 16. An embodiment of the commerce manager is described in greater detail in relation to FIG. 2.

The network 104, in one embodiment, is a data communication structure that allows computing devices to share data. The network 104 may be any type of communication structure capable of sharing data between computing devices. Examples of the network 104 include an Ethernet network, a LAN, a Wi-Fi network, a WAN, an Extranet, and the Internet.

The client 106, in some embodiments, is a computing device to display information from the server 102. The computing device may receive data from the server 102 over the network 104. In some embodiments, the computing device transmits information to the server 102 over the network 104.

The client 106 may be any type of computing device capable of interacting with the server 102 to request a purchase. For example, the client 106 may be a computing device running a web browser. In another embodiment, the client 106 may operate an application designed to work with the commerce manager 108, such as a custom app. The client may be a desktop computer, a laptop computer, a tablet computer, a smart phone, a PDA, a media player, or any other type of computing device.

In some embodiments, the commerce manager 108 receives data from a data source. The data source may be a local data source 110, a third party data source 112, or a remote data source 114. The local data source 110 may include a data storage device in the same location as the server 102. For example, the local data source 110 may be a database operating on the server. As used herein, the term “manager” refers to a process operating on a computer or similar electronic computing device that manipulates and transforms one or more numerical inputs represented as physical (e.g. electronic) quantities within the computer system's registers and memories into other data similarly represented as physical quantities within the computer system memories or registers or other such information storage, transmission, or display device.

The third party data source 112, in one embodiment, provides data to the commerce manager 108 from a third party. For example, the third party data source 112 may be controlled by a third party seller of products that wishes to sell products using the commerce manager 108. The third party data source 112, may be located in the same location as the server 102. For example, the third party data source 112 and the server 102 may be located in the same data center. In another embodiment, the third party data source 112 may be located remotely from the server 102. For example, the third party data source 112 may be located at a remote data center and communicate with the commerce manager via the network 104.

The remote data source 114, in some embodiments, provides data to the commerce manager 108 from a remote location. The remote data source 114 may communicate with the commerce manager via the network 104.

The data received from the data source (the local data source 110, the third party data source 112, or the remote data source 114) may be used by the commerce manager 108 to dynamically influence a price for a product. The data may include information related to the demand for the product, the supply for a product, a buyer of the product, a prospective buyer of the product, or other information. For example, the data may include a parameter relating to the number of products available for sale.

The products offered for sale via the system 100 may be any type of products. For example, the products may be physical goods, digital goods, or services.

FIG. 2 is a block diagram depicting one embodiment of the commerce manager 108 of FIG. 1. The commerce manager 108 may include a demand variable generator 202, a supply variable generator 204, a dynamic price manager 206, a price history display generator 208, a checkout manager 210, a seller queue manager 212, and a bank manager 214. The commerce manager 108 manages online sales of a product.

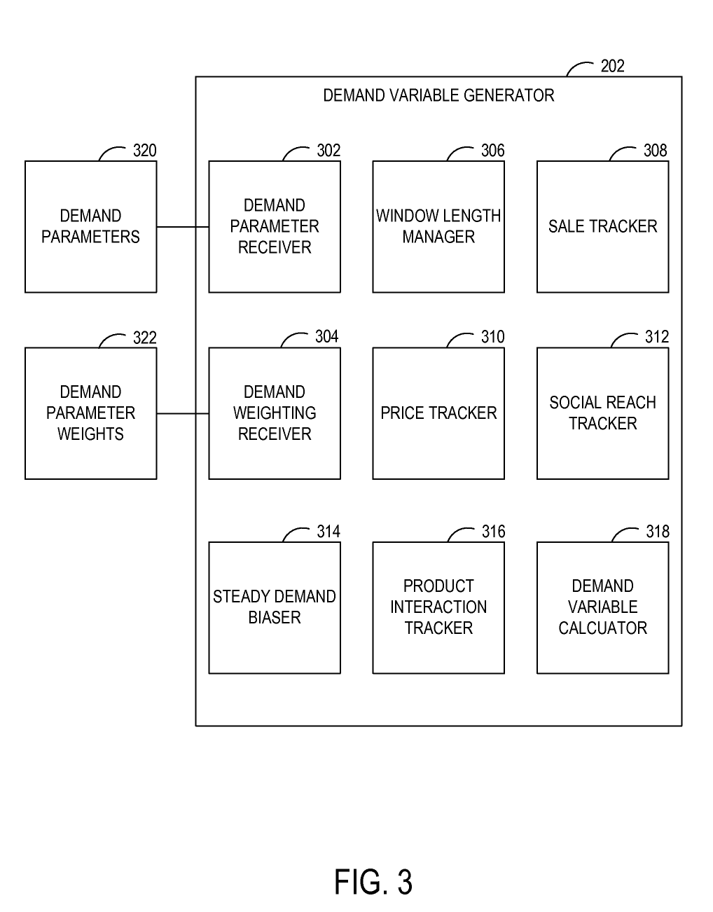

The demand variable generator 202, in one embodiment, generates a demand variable based on market cues that relate to the demand of a product. The demand variable generator 202 may produce a value based on one or more parameters that indicate demand for a product. The value may be produced computationally by applying the parameters to an algorithm. The algorithm may weight and combine a plurality of parameters to produce the demand variable. In one embodiment, the demand variable generator 202 generates the demand variable periodically, such as at a predetermined time interval. The demand variable generator 202 is described in greater detail in relation to FIG. 3.

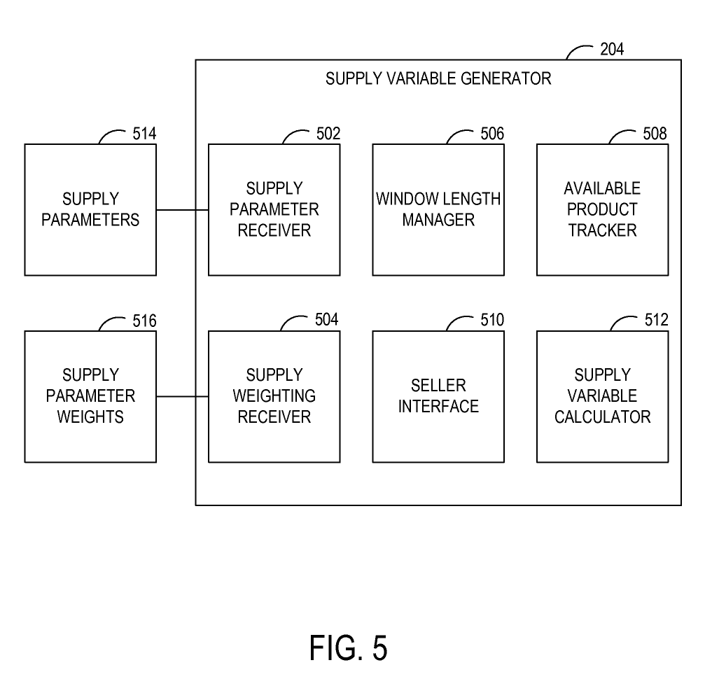

The supply variable generator 204, in one embodiment, generates a supply variable based on market cues that relate to the supply of a product. The supply variable generator 204 may produce a value based on one or more parameters that indicate supply for a product. The value may be produced computationally by applying the parameters to an algorithm. The algorithm may weight and combine a plurality of parameters to produce the supply variable. In one embodiment, the supply variable generator 204 generates the supply variable periodically, such as at a predetermined time interval. The supply variable generator 204 is described in greater detail in relation to FIG. 5.

In some embodiments, the dynamic price manager 206 determines a price for a product. The dynamic price manager 206 may update the price for the product periodically. For example, the dynamic price manager 206 may generate a new price for the product in response to the passage of a predetermined time interval. In another embodiment, the dynamic price manager 206 may update the price for the product at a rate influenced by parameters relating to the product. For example, the dynamic price manager 206 may increase the frequency of price generation in response to an increased rate of change of the generated price. In another example, the dynamic price manager 206 may change the frequency of price generation in response to a change in a parameter that relates to supply of the product or demand of the product. In one embodiment, the dynamic price manager 206 updates the price every four seconds.

The dynamic price manager 206, in some embodiments, generates a price for the product in response to market cues that indicate supply and/or demand. For example, the dynamic price manager 206 may generate a price in response to values produced by the demand variable generator 202 and/or the supply variable generator 204.

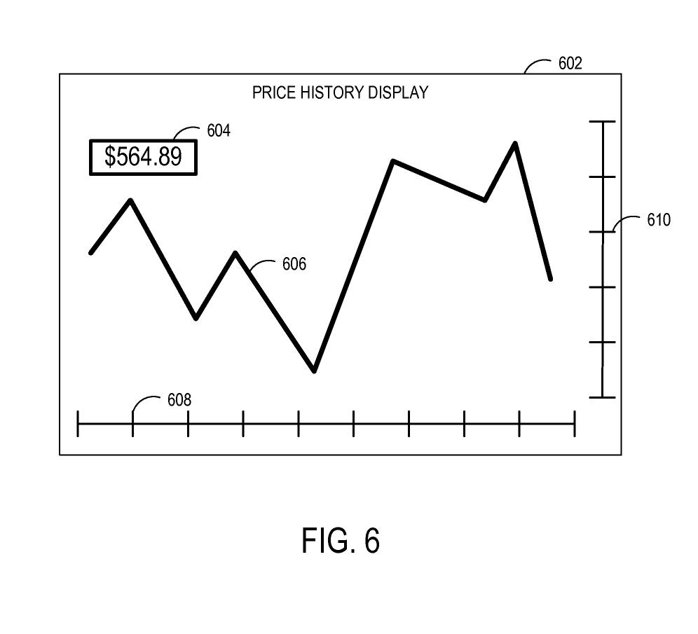

The price history display generator 208, in one embodiment, generates a display that shows historical pricing for a product. The price history display generator 208 may receive pricing information over a period of time for a product and assemble the pricing information into a displayable format. For example, the price history display generator 208 may produce a price history display that is a scatter plot of time versus price. One example of a price history display is described in relation to FIG. 6. In some embodiments, the price history display generator 208 causes the price history display to be displayed at the client 106.

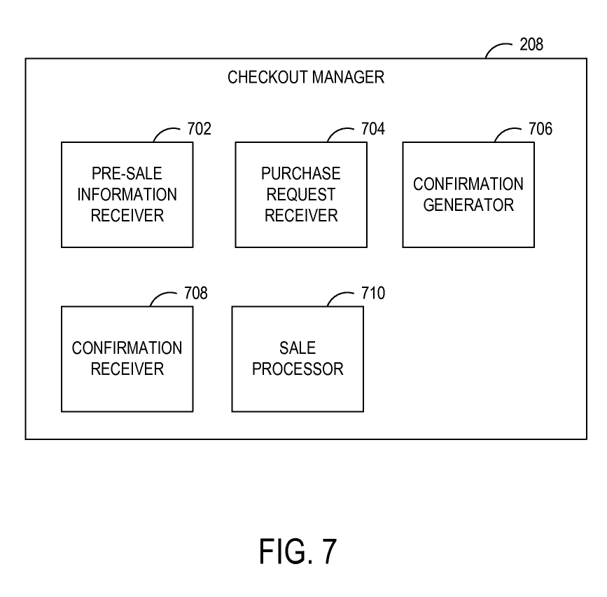

In some embodiments, the checkout manager 210 manages a checkout process wherein a buyer commits to purchase a product. The checkout manager 210 may receive payment and shipping information from the buyer. The checkout manager 210 may provide a limited time window wherein the buyer has the option to purchase the product at a particular locked price, even as the price is being updated by the dynamic price manager 206. One embodiment of a checkout manager 210 is described in greater detail in relation to FIG. 7.

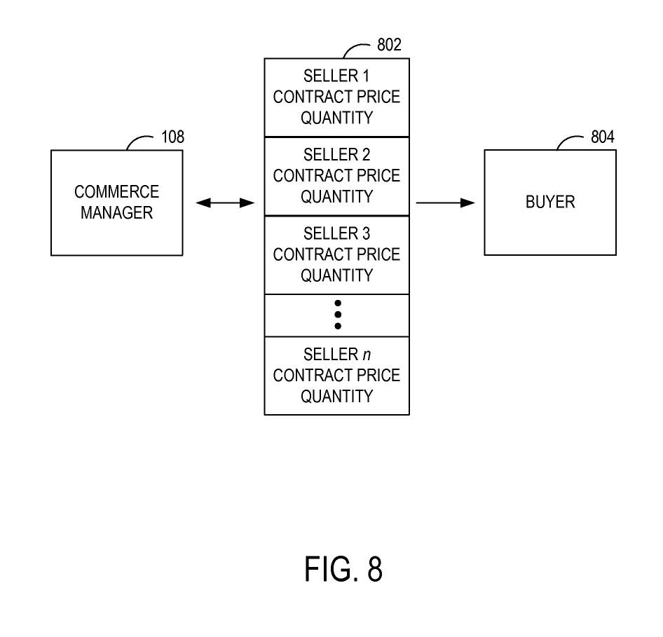

The seller queue manager 212, in one embodiment, orders a plurality of sellers to determine which seller will be assigned a given purchase of a product. The seller queue manager 212 may receive information including a number of products available from a particular seller and a price which the seller will accept for the products (the “contract price”). The seller queue manager 212 may change the order of the seller queue in response to a particular sale price for the product or other factors. One embodiment of a seller queue is illustrated in relation to FIG. 8.

In some embodiments, the bank manager 214 manages a fund that can be used by the commerce manager 108 to reduce the generated sale price. This fund is referred to herein as the “bank.” The bank manager 214 may receive funds from sales that occur with prices higher than the contract price established by the seller, resulting in excess funds. In some embodiments, the bank manager 214 may receive funds from sales that occur with prices higher than the contract price established by the seller plus a fee charged by the operator of the commerce manager 108, resulting in excess funds. Some or all of these excess funds may be allocated to the bank and may be applied to a particular sale to reduce the generated sale price. The bank manager 214 may produce a price reduction variable. The price reduction variable may be communicated to the dynamic price manager 206. The price reduction variable may cause the dynamic price manager 206 to reduce the price below the price that would otherwise be calculated in response to other market cues. In one embodiment, the seller is paid the contract price by the operator of the commerce manager 108. The bank manager 214 may allocate a portion of excess funds from one or more previous sales to the payment to the seller to make up the difference between the sale price and the contract price. In another embodiment, the seller is paid the contract price minus an agreed upon amount, such as a percentage of the contract price. The bank manager 214 may allocate a portion of excess funds from one or more previous sales to the payment to the seller to make up the difference between the sale price minus the agreed upon amount and the contract price

In some embodiments, a sale may be at a particular price above a contract price established for the seller to which the purchase is assigned. The difference between the sale price and the contract price may be allocated by the bank manager 214. Some or all of the difference may be allocated as profit to the operator of the commerce manager 108. Some or all of the difference may be allocated to the bank. For example, the bank manager 214 may be configured to allocate a particular percentage of the difference for a sale to the bank. In another example, the bank manager 214 may be configured to allocate funds from particular sales or particular products to the bank. In yet another example, the bank manager 214 may track which products produce the excess funds and apply those excess funds to the same product. In another example, the bank manager 214 may pool excess funds across products and apply the excess funds to sales of different products.

In certain embodiments, sales influenced by the bank manager 214 may be at a price below any contract price for any seller in the seller queue for a particular product. The seller queue manager 212 may select a particular seller in the seller queue for such a “below contract” sale and allocate the purchase to that seller. The seller in the below contract sale may be compensated in accordance with their contract price by combining funds received from the buyer with funds from the bank. In some embodiments, the seller queue manager 212 will select the seller in the seller queue with the lowest contract price when a below contract sale is consummated. In another embodiment, the seller queue manager 212 may take other factors into consideration when selecting a seller for a below contract sale. For example, a seller may have entered into a relationship with the operator of the commerce manager 108 such that the seller shares costs associated with the bank, and therefore be selected for the below contract sale.

By allowing the bank manager 214 to reduce the price of some sales below the market price that would otherwise be generated by the dynamic price manager 206, the operator of the commerce manager 108 has an opportunity to create excitement among buyers. Buyers will have the chance to purchase some products below market price, and will be able to track current prices on a price history display. When the buyer sees a price displayed that is acceptable, that buyer can initiate a purchase of the product via the checkout manager 210.

FIG. 3 is a block diagram depicting one embodiment of the demand variable generator 202 of FIG. 2. The demand variable generator 202 includes a demand parameter receiver 302, a demand weighting receiver 304, a window length manager 306, a sale tracker 308, a price tracker 310, a social reach tracker 312, a steady demand biaser 314, a product interaction tracker 316, and a demand variable calculator 318. The demand variable generator 202 generates a value (a “demand variable”) that indicates demand for a product and passes that demand variable to the dynamic price manager 206.

The demand parameter receiver 302 receives one or more demand parameters 320. The demand parameters 320 may be any type of parameter that indicates demand for a product. For example, the demand parameters 320 may include information relating to sales of a product, price of the product, social reach of prospective buyers viewing the product, rate of change of demand for the product, and interaction by prospective buyers with information about the product. As will be appreciated by those skilled in the art, any type of quantifiable information that provides indicia of demand may be used as a demand parameter 320 by the demand variable generator 202, and should be deemed to be within the scope of the disclosure.

The demand parameter receiver 302 may receive demand parameters 320 from any source. For example, the demand parameter receiver 302 may receive a demand parameter 320 from a local data source 110, such as in the form of internal sales statistics compiled by the commerce manager 108. In another example, the demand parameter receiver 302 may receive a demand parameter 320 from a third party data source 112, such as in the form of social media account information related to a prospective buyer. In another example, the demand parameter receiver 302 may receive a demand parameter 320 from a remote data source 114, such as in the form of forecast data from a seller.

The demand weighting receiver 304, in one embodiment, receives one or more demand parameter weights 322 to be applied to the one or more demand parameters 320. The demand parameter weights 322 may indicate the relative significance of one or more demand parameters 320 in computing the demand variable. The demand parameter weights 322 may be predetermined or arbitrarily determined by the operator of the commerce manager 108. In one embodiment, a demand parameter weight may be automatically adjusted by the demand variable generator 202 in response to a condition being met.

In some embodiments, the demand variable generator 202 generates a demand variable using demand parameters 320 relating to a particular period of time or “window.” The demand variable generated by the demand variable generator 202 reflects information from the window and may exclude information outside of the window. The window length manager 306 may manage the window for which the demand variable generator 202 processes demand parameters. The window may be a predetermined period of time. For example, the window length manager 306 may indicate that the demand variable generator 202 should use data over the twenty four hours prior to the generation of the demand variable. This window may be any predetermined period of time, and may be configurable by the operator of the commerce manager 108. In some embodiments, the window length manager 306 may automatically adjust the window, for example in response to a change in volatility of the demand variable or another parameter.

The sale tracker 308, in one embodiment, tracks sales of a product. The sale tracker 308 may receive a demand parameter 320 that indicates that the commerce manager 108 has completed one or more sales of the product. In some embodiments, the sale tracker 308 may track sales which take place through sales engines other than the commerce manager 108. The price tracker 310, in some embodiments, tracks the price associated with a product.

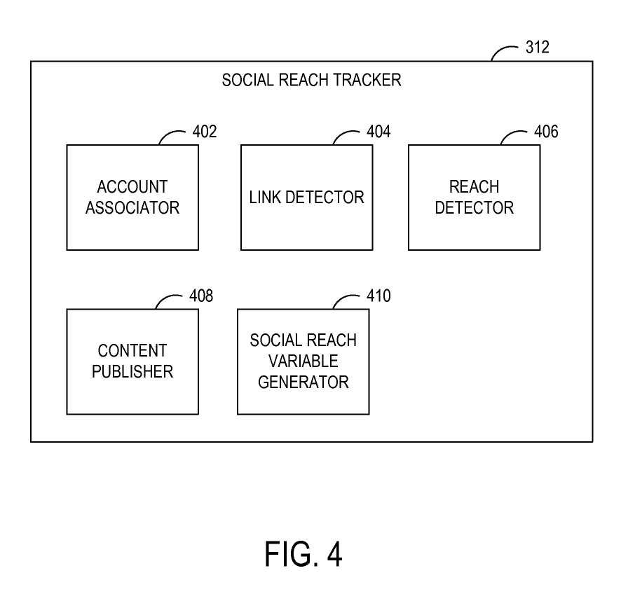

In certain embodiments, the social reach tracker 312 tracks the reach of a prospective buyer on a social media network (the “social reach” of the prospective buyer). The social reach of a prospective buyer may be an indicator that impacts the demand variable. If the social reach tracker 312 determines that the social reach of a prospective buyer is particularly high, and the prospective buyer shares with his social network that he or she is considering the product, the demand variable generator 202 may use this social reach as a demand parameter 320. For example, if the prospective buyer publishes a link to the product to a particularly large number of friends on Facebook, those friends will be exposed to the product. The demand variable generator 202 may respond to this by reducing the demand variable, and thus, the generated price for the product. This provides an incentive for prospective buyers to publish the purchases they are considering and increases the pool of prospective buyers. One embodiment of a social reach tracker is described in greater detail in relation to FIG. 4.

The steady demand biaser 314, in one embodiment, adjusts the demand variable downward in response to the demand for the product being substantially constant. The steady demand biaser 314 may reduce the demand variable in the absence of other parameters that indicate a decreased demand.

The product interaction tracker 316, in some embodiments, tracks interaction with a product by a prospective buyer. The product interaction tracker 316 may translate product interaction into a demand parameter 320. For example, the product may be displayed on a product page on a client 106. A prospective buyer may navigate to the product page and view the page for a trackable amount of time. The amount of time that the page is viewed may be translated by the product interaction tracker 316 into a demand parameter 320. In another example, the product interaction tracker 316 may track a position of a pointer on the product page to generate a demand parameter 320.

In certain embodiments, the demand variable calculator 318 calculates a demand variable based on demand parameters 320 and demand parameter weights 322. The demand variable calculator 318 may apply a computational formula to one or more demand parameters to produce the demand variable. For example, in one embodiment, the demand variable calculator 318 produces an average of weighted demand parameters. As will be appreciated by those skilled in the art, the demand variable calculator may apply other known computational formulas to the one or more demand parameters, and such other computational formulas should be considered to be within the scope of this disclosure.

FIG. 4 is a block diagram depicting one embodiment of the social reach tracker 312 of FIG. 3. The social reach tracker 312 includes an account associator 402, a link detector 404, a reach detector 406, a content publisher 408 and a social reach variable generator 410. The social reach tracker determines a social reach of a buyer or a prospective buyer. In the description for this figure, “buyer” may be used to describe a person who purchases, who has purchased, or who may in the future purchase a particular product.

The account associator 402, in one embodiment, associates the buyer with a social media account. The account associator 402 may receive an input from the buyer that indicates that a particular social media or social network account belongs to the buyer. In some embodiments, the account associator 402 receives permission to access the social media or social network account to evaluate the social reach of the buyer. In one embodiment, the account associator 402 receives a password to access the social media or social network account.

The link detector 404, in some embodiments, detects if the buyer has shared a link to the product with other people associated via the social network or social media account. For example, the buyer may share a link to the product via Twitter, and in response, the link detector 404 may determine that the buyer has shared the link. By detecting if a link has been shared, the link detector 404 allows the social reach tracker 312 to determine if the product has been presented to others associated with the social media or social network account.

The reach detector 406, in one embodiment, determines a quantity of contacts associated with the social network or social media account. For example, the reach detector 406 may access the number of friends associated with a Facebook account. In another example, the reach detector 406 may determine the number of followers for a Twitter account.

In some embodiments, the reach detector 406 evaluates or weights the quality of the contacts associated with the social media or social network account. For example, the account may be a Google+ account, and the contacts may be arranged into different circles. The reach detector 406 in this example may apply more weight to contacts in a “close friends” circle and less weight to contacts in a “business associates” circle.

The content publisher 408, in one embodiment, publishes content related to a product to the social media or social network account that is viewable to contacts associated with the account. The content publisher 408 may publish any type of content, including, but not limited to, a link to the product, a description of the product, an indication that the buyer is browsing the product, an indication that the buyer has purchased the product, or the current price of the product. In some embodiments, the content publisher 408 acts in response to a request from the buyer. For example, the product page may include a “share” button that, when activated by the buyer, publishes the buyer's interest to the social media or social network account. In another embodiment, the content publisher 408 acts automatically. For example, the content publisher 408 may automatically publish an indication that the buyer has purchased the product in response to the buyer purchasing the product.

The social reach variable generator 410, in certain embodiments, calculates a social reach variable. The social reach variable may be calculated by a mathematical formula based on parameters received by the social reach tracker 312. In one embodiment, the social reach variable generator 410 calculates the social reach variable based on the social reach determined by the reach detector 406.

In some embodiments, the social reach variable is passed to the demand variable calculator 318 for use as a demand parameter 320. For example, a prospective buyer may be associated with a social network account via the account associator 402. The link detector 404 may detect that the prospective buyer has shared a link to a product with contacts associated with the account. The reach detector 406 may determine the number of contacts associated with the account. The social reach variable generator 410 may compute a social reach variable based on the social reach and pass the social reach variable to the demand variable calculator 318 as a demand parameter 320. The social reach variable may be weighted and used as one component to produce the demand variable by the demand variable calculator 318. The magnitude of the prospective buyer's social reach may impact the demand variable in that a relatively large social reach may result in a relatively lower demand variable. This relatively lower demand variable may result in a relatively lower price generated by the dynamic price manager 206, leading to a lower purchase price for the prospective buyer.

The social reach variable may also be calculated by the social reach variable generator 410 after a sale. For example, in response to a purchase of a product by a buyer, the content publisher 408 may publish to an associated social network an indication that the buyer has purchased the product. The reach detector 406 may determine the number of contacts to whom this indication is presented. The social reach variable generator may than use the social reach information to compute the social reach variable. The social reach variable may be weighted and used as one component to produce the demand variable by the demand variable calculator 318. The magnitude of the buyer's social reach may impact the demand variable in that a relatively large social reach may result in a relatively lower demand variable. This relatively lower demand variable may result in a relatively lower price generated by the dynamic price manager 206, leading to a lower purchase price for a future prospective buyer.

FIG. 5 depicts one embodiment of the supply variable generator 204 of FIG. 2. The supply variable generator 204 includes a supply parameter receiver 502, a supply weighting receiver 504, a window length manager 506, an available product tracker 508, a seller interface 510, and a supply variable calculator 512. The supply variable calculator 204 calculates a value (a “supply variable”) based on supply parameters 514 that indicate a level of supply for the product.

The supply parameter receiver 502 receives one or more supply parameters 514. The supply parameters 514 may be any type of parameter that indicates supply for a product. For example, the supply parameters 514 may include information relating to available quantity of a product, projections of future availability of a product, and rate of change of supply for the product. As will be appreciated by those skilled in the art, any type of quantifiable information that provides indicia of supply may be used as a supply parameter 514 by the supply variable generator 204, and should be deemed to be within the scope of the disclosure.

The supply parameter receiver 502 may receive supply parameters 514 from any source. For example, the supply parameter receiver 502 may receive a supply parameter 514 from a local data source 110, such as in the form of internal product availability statistics compiled by the commerce manager 108. In another example, the supply parameter receiver 502 may receive a supply parameter 514 from a third party data source 112, such as in the form of inventory information provided by a seller. In another example, the supply parameter receiver 502 may receive a supply parameter 514 from a remote data source 114, such as in the form of inventory forecast data from a seller.

The supply weighting receiver 504, in one embodiment, receives one or more supply parameter weights 516 to be applied to the one or more supply parameters 514. The supply parameter weights 516 may indicate the relative significance of one or more supply parameters 514 in computing the supply variable. The supply parameter weights 516 may be predetermined or arbitrarily determined by the operator of the commerce manager 108. In one embodiment, a supply parameter weight may be automatically adjusted by the supply variable generator 204 in response to a condition being met.

In some embodiments, the supply variable generator 204 generates a supply variable using supply parameters relating to a particular period of time or “window.” The supply variable generated by the supply variable generator 204 reflects information from the window and may exclude information outside of the window. The window length manager 506 may manage the window for which the supply variable generator 204 processes supply parameters 514. The window length may be a predetermined period of time. For example, the window length manager 306 may indicate that the supply variable generator 204 should use data over the twenty four hours prior to the generation of the supply variable. This window may be any predetermined period of time, and may be configurable by the operator of the commerce manager 108. In some embodiments, the window length manager 506 may automatically adjust the window, for example in response to a change in volatility of the demand variable or another parameter.

The available product tracker 508, in one embodiment, tracks the amount of product available. The available product tracker 508 may access the seller queue to determine the number of a particular product that is available for sale in the seller queue. In some embodiments, the available product tracker 508 may access external sources of product availability, such as seller inventory, distributor inventory, or inventory forecasts. The available product tracker 508 may pass one or more values related to the available inventory for a product to the supply variable calculator 512.

In certain embodiments, the seller interface 510 provides an interface for a seller to communicate supply information. The seller interface 510 may receive inventory information from the seller. In some embodiments, the seller interface 510 receives a number of products available for sale from the seller at a particular price.

The supply variable calculator 512, in one embodiment, calculates a supply variable based on supply parameters 514 and supply parameter weights 516. The supply variable calculator 512 may apply a computational formula to one or more supply parameters to produce the supply variable. For example, in one embodiment, the supply variable calculator 512 produces an average of weighted supply parameters. As will be appreciated by those skilled in the art, the supply variable calculator 512 may apply other known computational formulas to the one or more demand parameters, and such other computational formulas should be considered to be within the scope of this disclosure.

FIG. 6 depicts one embodiment of a price history display 602. The price history display provides a representation of the generated price for a product over a period of time. The price history display 602 is displayed on the client 106 and generated by the price history display generator 208.

In one embodiment, the price history display 602 includes a current price display 604. The current price display 604 indicates the current price for the product. The current price display 604 may be updated as new prices for the product are generated by the dynamic price manager 206. In some embodiments, the current price display 604 may indicate prices in alternative currencies. In certain embodiments, the buyer may select the currency in which the current price display 604 indicates the current price.

The price history display 602 includes a price track 606 in some embodiments. The price track 606 may be a scatter plot with historical prices plotted on a Cartesian coordinate system. In one embodiment, the historical prices may be connected by lines. The connecting lines may be straight or may be mathematically smoothed. The price track 606 may be updated as new prices for the product are generated by the dynamic price manager 206. In one embodiment, the price track 606 is updated incrementally as a new price is generated. In another embodiment, the price track scrolls between price updates.

In one embodiment, the price history display 602 includes a horizontal scale 608. The horizontal scale 608 indicates the scale of the Cartesian coordinate system in the X-axis. In one embodiment, the horizontal scale 608 indicates time. The horizontal scale 608 may indicate absolute time (e.g. GMT), may be customized by a buyer to indicate local time (e.g. EST), or may indicate relative time (e.g. 1 minute ago, 2 minutes ago, etc.). In some embodiments, the horizontal scale 608 may include numerical indicators to indicate the scale. In certain embodiments, the buyer may select alternate scales for the horizontal scale 608 (e.g. 10 minutes, 1 day, 5 days, 6 months, year to date, 1 year, all, etc.)

In some embodiments, the price history display 602 includes a vertical scale 610. The vertical scale 610 indicates the scale of the Cartesian coordinate system in the Y-axis. In one embodiment, the vertical scale 610 indicates price of the product. The vertical scale 610 may indicate absolute price for the product. The vertical scale 610 may be dynamically generated such that the range of minimum and maximum prices on the vertical scale 610 is the same as or slightly larger than the range of the displayed price track 606. In one embodiment, the vertical scale 610 displays percentage change of the price, for example, percentage change from a mean price, from a maximum price, or from a minimum price. In some embodiments, the vertical scale 610 may include numerical indicators to indicate the scale.

FIG. 7 is a block diagram depicting one embodiment of the checkout manager 210 of FIG. 2. The checkout manager 210 includes a pre-sale information receiver 702, a purchase request receiver 704, a confirmation generator 706, a confirmation receiver 708, and a sale processor 710. The checkout manager 210 manages the checkout process for the sale of a product.

The pre-sale information receiver 702, in one embodiment, receives pre-sale information from a prospective buyer. The pre-sale information may include payment information, such as a credit card account, an online payment account (e.g. PayPal), or account billing information (e.g. a billing address, a CVV2 code, or social network login credentials for the prospective buyer). In some embodiments, the pre-sale information received by the pre-sale information receiver 702 includes a shipping address. The pre-sale information receiver 702 may act in conjunction with an account registration process. In some embodiments, the information received by the pre-sale information receiver 702 is useable upon login by a registered buyer.

The purchase request receiver 704, in some embodiments, receives a request from a prospective buyer to purchase a product. The request is initiated in response to a selection by the prospective buyer of a product at a price. For example, the current price display 604 may indicate a current price for the product, and the prospective buyer may select a “buy” button while that current price is displayed. The then current price becomes the locked price in response to selection of the buy button. In response, the purchase request receiver 704 passes the purchase request to other components of the checkout manager 210 for further processing.

In some embodiments, the confirmation generator 706 generates a confirmation request for display to the buyer in response to receiving a purchase request. The confirmation request includes an indicator that may be selected by the prospective buyer to confirm purchase of the product at the locked price. In some embodiments, the prospective buyer may enter information relating to multiple payment methods (e.g. more than one credit card, Google Checkout, Paypal, Amazon Payments, etc.) in the pre-sale information receiver 702, and the confirmation generator 706 generates a selectable option for the prospective buyer to select among the multiple payment methods.

The confirmation request generated by the confirmation generator 706 is available to the buyer for a predetermined period of time in one embodiment. For example, the confirmation request may expire after ten seconds, after which the locked price expires and the prospective buyer cannot confirm purchase of the product at the locked price. In some embodiments, the prospective buyer may make a new purchase request via the purchase request receiver 704 after expiration of the confirmation request, but the price available for the new purchase request will be determined by the price at the time of the new purchase request. The predetermined period of time for expiry of a confirmation request may be configurable by the operator of the commerce manager 108 or by a seller. In some embodiments, the predetermined period of time for expiry of a confirmation request may be automatically modified in response to a condition being met. For example, additional time may be added to for prospective buyers that have multiple payment methods. In another example, time may be added or subtracted based on the locked price. In some embodiments, the predetermined period of time is between three and thirty seconds. In another embodiment, the predetermined period of time is between eight and twelve seconds. In another embodiment, the predetermined period of time is approximately ten seconds.

In one embodiment, the confirmation receiver 708 receives confirmation from the prospective buyer in response to selection of the indicator by the prospective buyer. In response to receipt of confirmation by the confirmation receiver 708, the sale processor 710 in some embodiments processes the sale of the product to the prospective buyer, who is now a “buyer.” The sale processor 710 accesses the pre-sale information received by the pre-sale information receiver 702 and charges the buyer via the selected payment option provided by the buyer.

FIG. 8 depicts one embodiment of a seller queue 802. The seller queue 802 includes a plurality of positions. Each position in the seller queue includes information that describes a seller for a product, a price that the seller will accept for the product (the “contract price”), and the number of products that the seller will offer for the given contract price.

The plurality of positions are arranged such that there is a first position (labeled “Seller 1”), a second position (labeled “Seller 2”), and so forth up to an nth position (labeled “Seller n”). The seller queue manager 212 assigns a seller to a position in the seller queue 802 in response to a request from the seller to be included in the seller queue 802. The seller queue manager 212 may assign the seller to any position in the seller queue 802. In one embodiment, a seller is assigned to the first unoccupied position in the seller queue 802. For example, if the seller queue 802 is empty, the next seller to request to be placed in the seller queue 802 is placed in the first position. If the seller queue 802 has one seller in the first position, the next seller to be request to be placed in the seller queue 802 is assigned to the second position.

In another embodiment, the seller queue manager 212 determines the position of a seller to be placed in the seller queue 802 based on other factors. For example, a seller may set a particularly low contract price, and the seller queue manager 212 may place the seller higher in the seller queue 802 in response.

In some embodiments, a seller may occupy multiple positions in the seller queue 802. For example, a seller may make multiple submissions to the seller queue 802 having different contract prices. In this example, each submission may occupy a position in the seller queue 802. In another example, a seller may be granted multiple occurrences in the seller queue 802 based on other factors, such as a particularly low contract price or an agreement with the operator of the commerce manager 108.

The sale processor 710 of the checkout manager 210 selects a seller from the seller queue 802 to process a purchase. In one embodiment, the sale processor 710 selects the seller in the first position (i.e. Seller 1) to complete the sale. Once selected, the seller sends the product to a buyer 804 and receives payment for the purchase.

In response to assignment of a sale to the seller in the first position, the seller queue manager 212 may deduct the sale quantity from the seller's listed quantity and reorder the seller queue 802. In one embodiment, the seller queue manager 212 removes the first seller from the first position, moves all other sellers in the seller queue 802 up one position, and places the first seller at the end of the seller queue 802 in the first empty position. In another embodiment, the first seller may be placed in any other position in the seller queue 802 based on other factors, such as a particularly low contract price or an agreement with the operator of the commerce manager 108.

In some embodiments, in response to a purchase by a buyer 804, the sale processor 710 compares the sale price to the contract price established for the seller in the first position. If the sale price is less than the contract price, the sale processor 710 may proceed to the next position in the seller queue 802 and repeat the comparison for the next seller. The sale processor 710 may repeat this process until a seller with a contract price equal to or less than the sale price is located and assign the sale to that seller. The seller queue 802 may then be reordered such that the assigned seller is moved down the queue and the higher sellers having contract prices greater than the sale price remain in their previous positions.

In some embodiments, the bank manager 214 applies additional funds to a sale to meet a contract price in the seller queue 802 in response to the sale price being less than the contract price. In one embodiment, the bank manager 214 augments the sale price with funds sufficient to meet the lowest contract price of the sellers in the seller queue 802. The sale processor 710 may in response select the seller with the lowest contract price, assign the purchase to the seller, and direct the commerce manager 108 to remit the appropriate amount to the seller based on the seller's contract price by augmenting funds from the sale with funds from the bank.

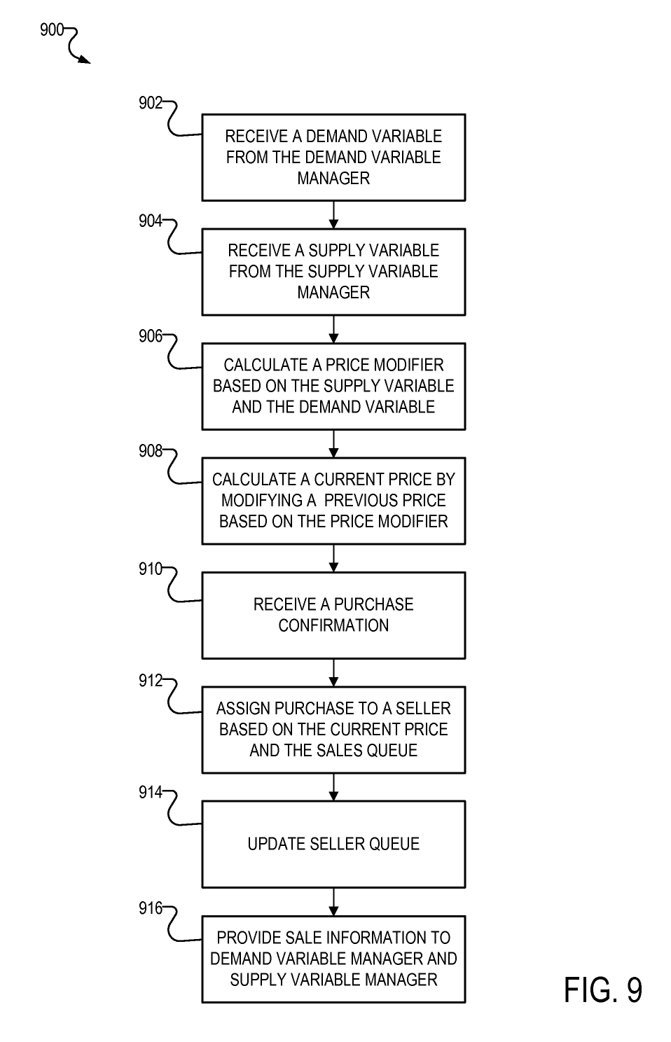

FIGS. 9-15 depict flowchart diagrams showing various embodiments of a method for operating a commerce manager 108. The methods are in certain embodiments methods of use of the system and apparatus of FIGS. 1-8, and will be discussed with reference to those figures. Nevertheless, the methods may also be conducted independently thereof and are not intended to be limited specifically to the specific embodiments discussed above with respect to those figures.

FIG. 9 depicts a flowchart diagram showing one embodiment of a method 900 for dynamically pricing a product. As shown in FIG. 9, the dynamic price manager 206 receives 902 a demand variable from the demand variable manager 202. The demand variable is a numerical value that indicates demand for a product. In some embodiments, the dynamic price manager 206 receives a supply variable from the supply variable manager 204. The supply variable is a numerical value that indicates a supply for a product.

The dynamic price manager 206, in some embodiments, calculates 906 a price modifier based on the supply variable and the demand variable. The price modifier may indicate that the previous price of the product should be incremented or decremented by an amount. The dynamic price manager 206 may use the price modifier to calculate 908 a current price for the product. The current price may be a previous price incremented or decremented by the amount specified by the price modifier.

The confirmation receiver 708 may receive 910 a purchase confirmation from a buyer. The sale processor 710 may assign 912 the purchase to a seller based on the sale price and the seller queue 802. The seller queue manager 212 may update 914 the seller queue 802, for example, by removing the assigned seller from its position in the seller queue 802 and placing the assigned seller at the bottom of the seller queue 802. Information about the sale may be provided 916 to the demand variable manager 202 and the supply variable manager 204. For example, the demand variable manager 202 may receive a notice that a sale has been processed for inclusion in the calculation to produce the demand variable.

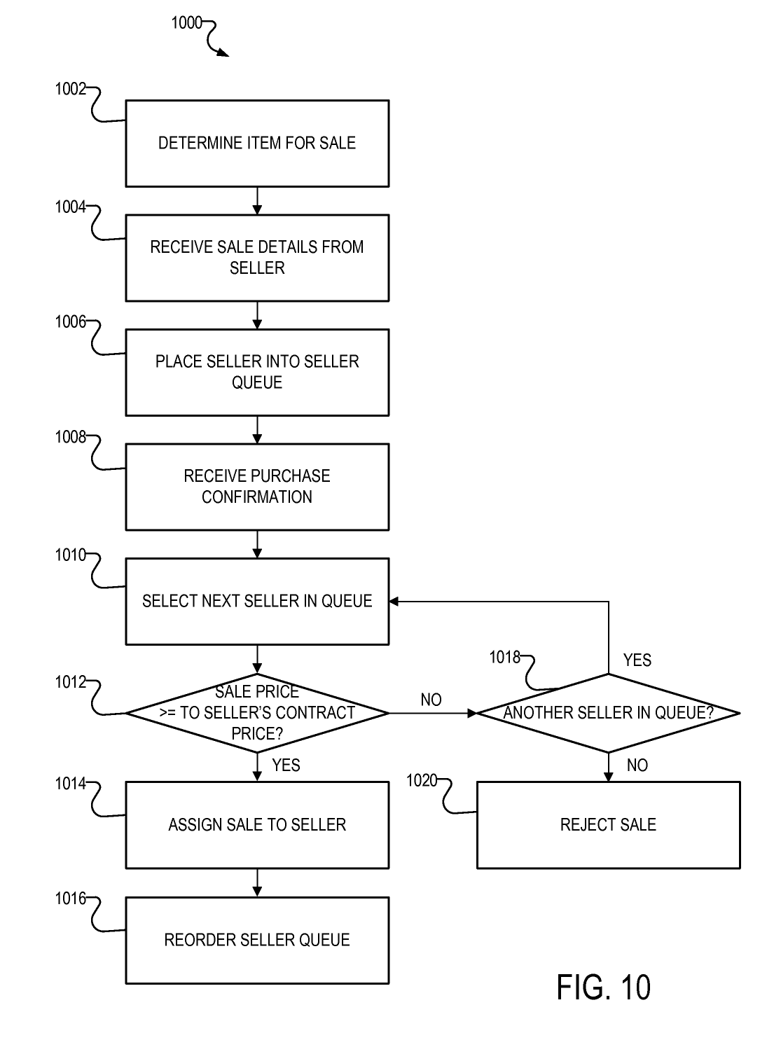

FIG. 10 depicts a flowchart diagram showing one embodiment of a method 1000 for assigning a purchase to a seller. As shown in FIG. 10, the commerce manager 108 determines 1002 an item for sale. The commerce manager 108 may publish a web page or other notice of availability of the item for sale. In some embodiments, the commerce manager 108 determines 1002 the item for sale in response to receiving an indication from the seller that the seller wishes to sell the product. In another embodiment, the commerce manager 108 determines 1002 the item for sale in response to receiving a request from a buyer that the buyer wishes to purchase a particular product.

The seller interface 510 may receive 1004 sale details from a seller. The sale details may include a quantity offered for sale by the seller and a contract price for the sale that indicates the amount the seller is willing to receive for the product.

The seller queue manager 212 places 1006 the seller into the seller queue 802. The seller may be placed 1006 at any position in the seller queue 802. In one embodiment, the seller is placed at the highest available position in the seller queue 802. In some embodiments, the seller may be placed in a higher position based on one or more factors including the contract price established by the seller, the quantity offered by the seller, and an agreement with the operator of the commerce manager 108.

The sale processor 710 receives 1008 a purchase confirmation that indicates that a buyer has committed to purchase a product. The purchase confirmation may include the price at which the purchase took place. In some embodiments, the price may be augmented by funds from the bank.

The sale processor 710 selects 1010 the next seller in the queue to evaluate if the purchase will be assigned to that seller. The sale processor 710 compares 1012 the purchase price to the contract price established for the seller, and if the purchase price is equal to or greater than the contract price for the seller, the sale processor 710 assigns 1014 the sale to the seller and reorders 1016 the seller queue 802 to reflect the sale. In some embodiments, the seller is moved to the last position in the seller queue 802.

In response to the sale processor 710 determining that the purchase price is greater than the contract price for the seller, the sale processor 710 determines 1018 if another seller is in the seller queue 802. If another seller is in the seller queue 802, the sale processor 710 returns to select 1010 the next seller in the seller queue 802. If there is not another seller in the seller queue 802, the sale processor 710 may reject 1020 the sale. In an alternative embodiment, the dynamic price manager 206 may determine a price such that a seller is in the seller queue 802 that has the product available for a contract price that will allow the purchase to proceed.

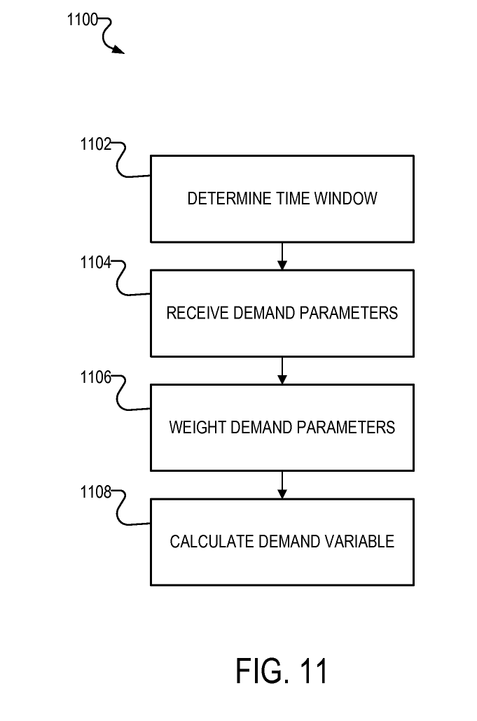

FIG. 11 depicts a flowchart diagram showing one embodiment of a method 1100 for generating a demand variable. The window length manager 306 determines 1102 a window of time over which demand parameters 320 are evaluated. The window may be any length of time, and may be arbitrarily selected or predetermined, or may be automatically adjusted based on trigger conditions.

In some embodiments, the demand parameter receiver 302 receives 1104 one or more demand parameters 320. The demand parameters 320 may be any type of parameter that can serve as an indicia of demand, including sales information, social media information, prospective buyer behavior information, etc. In some embodiments, the demand variable calculator 318 weights 1106 the demand parameters 320 using demand parameter weights 322. The demand parameter weights 322 may be arbitrarily selected, may be modifiable by the operator of the commerce manager 108, or may be automatically modified based on one or more triggers.

The demand variable calculator 318 calculates 1108 a demand variable for a product that indicates relative demand for the product. The demand variable calculator 318 may calculate the demand variable using a computational formula that includes one or more demand parameters 320 and one or more demand parameter weights 322.

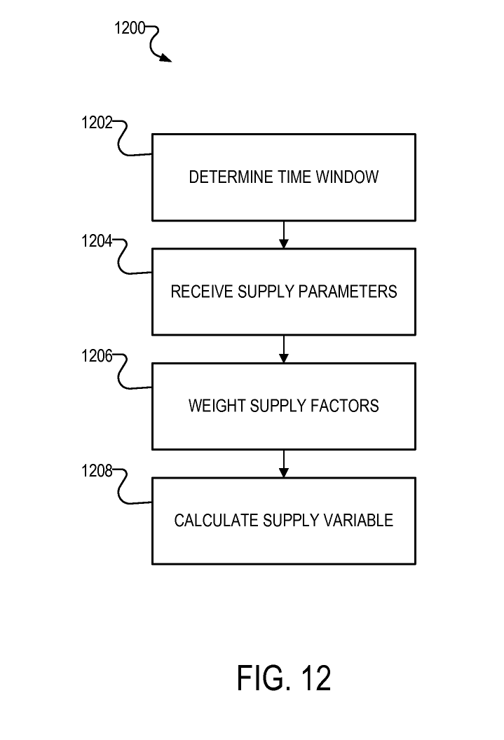

FIG. 12 depicts a flowchart diagram showing one embodiment of a method 1200 for generating a supply variable. The window length manager 506 determines 1202 a window of time over which supply parameters 514 are evaluated. The window may be any length of time, may be arbitrarily selected or predetermined, and may be automatically adjusted based on trigger conditions.

In some embodiments, the supply parameter receiver 502 receives 1204 one or more supply parameters 514. The supply parameters 514 may be any type of parameter that can serve as an indicia of supply, including sales information, inventory information, inventory forecast information, etc. In some embodiments, the supply variable calculator 512 weights 1206 the supply parameters 514 using supply parameter weights 516. The supply parameter weights 516 may be arbitrarily selected, may be modifiable by the operator of the commerce manager 108, and may be automatically modified based on one or more triggers.

The supply variable calculator 512 calculates 1208 a supply variable for a product that indicates relative supply for the product. The supply variable calculator 512 may calculate the supply variable using a computational formula that includes one or more supply parameters 514 and one or more supply parameter weights 516.

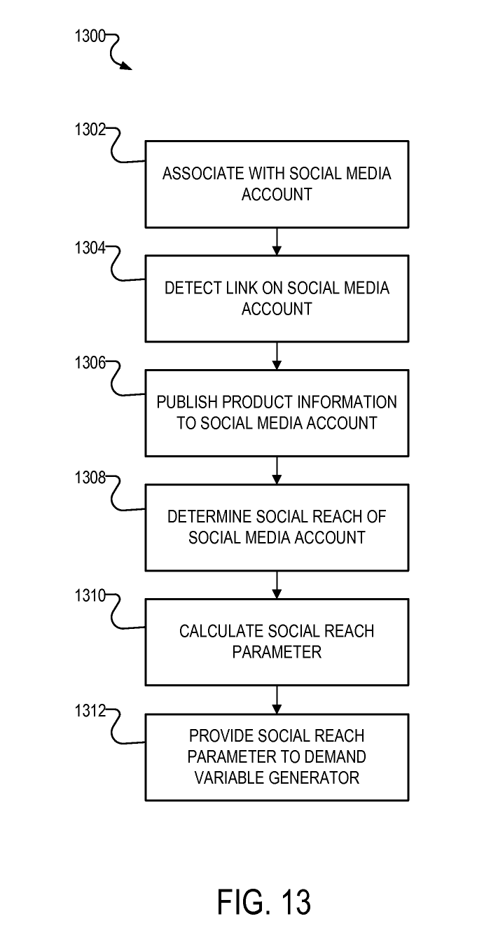

FIG. 13 depicts a flowchart diagram showing one embodiment of a method 1300 for generating a social reach variable. As shown in FIG. 13, the account associator 402 associates 1302 with a social media account of a prospective buyer. The prospective buyer may provide permission for the association, and may also provide a password to enable the association.

In some embodiments, the link detector 404 detects 1304 a link on the prospective buyer's social media account to a product for sale by the commerce manager 108. The link detector 404 may scan the prospective buyer's account to determine if the prospective buyer has published a link to the product. In another embodiment, the link detector 404 may work in conjunction with a content publisher 408 which automates publication 1306 of the product on the prospective buyer's social media account.

The reach detector 406 may determine 1308 a social reach of the prospective buyer's social media account. The social reach may be a measure of the quantity of connections or contacts associated with the prospective buyer's social media account. The social reach variable generator 410 may calculate 1310 a social reach parameter for the product based on the social reach. The social reach tracker 312 may provide 1312 the social reach parameter to the demand variable generator 202 for inclusion in the calculation to determine the demand variable.

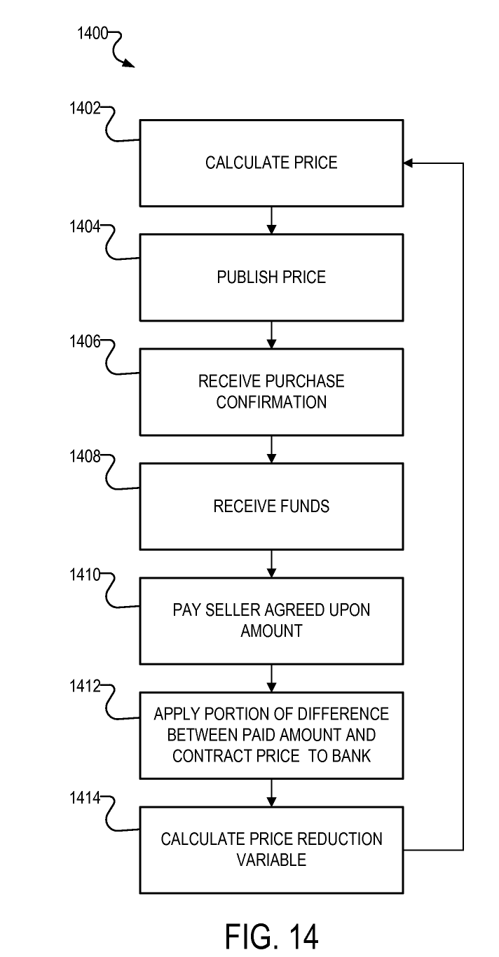

FIG. 14 depicts a flowchart diagram showing one embodiment of a method 1400 for reducing a price based on previous profits. As shown in FIG. 14, the dynamic price manager 206 calculates 1402 a price for a product. The commerce manager 108 publishes 1404 the calculated price in preparation for sale of the product.

In response to confirmation of a purchase by a buyer, the confirmation receiver 708 receives 1406 a purchase confirmation for the product. The sale processor 710 receives 1408 funds from the buyer and pays 1410 the seller the agreed upon amount to complete the transaction. In one embodiment, the seller is paid the contract price. In another embodiment, the seller is paid the contract price minus an agreed upon amount, such as a percentage of the contract price.

For some sales, the amount of funds received may be more than the contract price established for the seller to which the purchase is assigned. The difference between the received funds and the contract price may be allocated to the profits of the operator of the commerce manager 108, to a bank that applies funds to reduce sales prices below the lowest contract price for a product, or both. In some embodiments, the bank manager 214 applies 1412 a portion of the difference to the bank.

The bank manager 214 may apply the funds in the bank to sales to reduce the published price to a point below the lowest contract price for the product. In one embodiment, the bank manager 214 calculates 1414 a price reduction variable for the product. The price reduction variable may be computationally calculated based on one or more factors, including the amount of money in the bank, the amount of money in the bank received from sales of the product, the demand variable, the supply variable, and volatility related to the product, such as price volatility. The bank manager 214 may provide the price reduction variable to the dynamic price manager 206 for inclusion in the calculation 1402 of the next dynamic price. The price reduction variable may cause the dynamic price manager to reduce the price of the product.

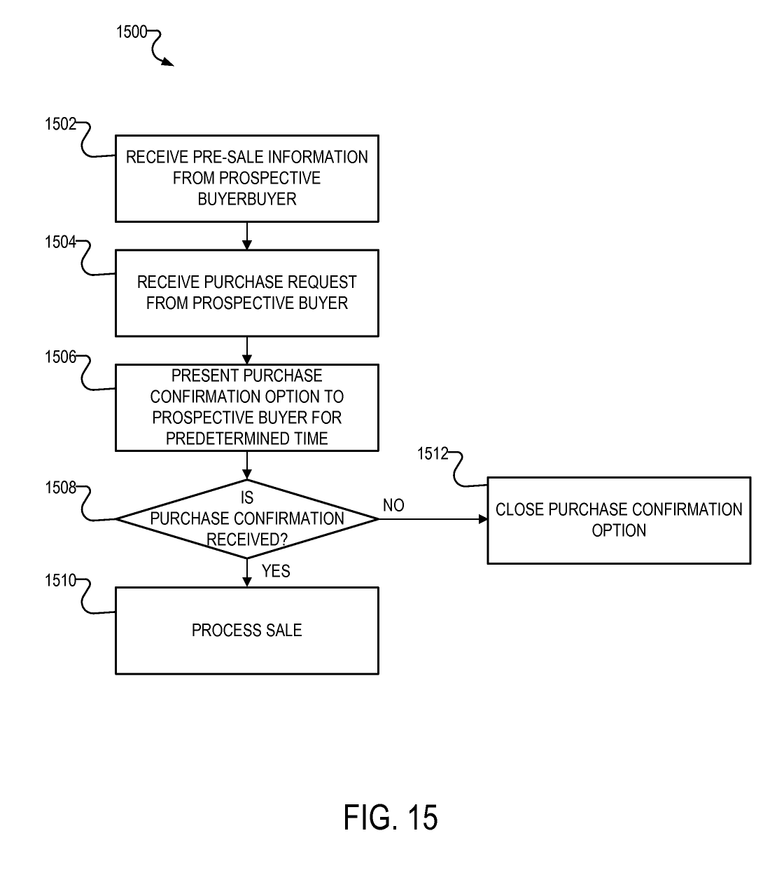

FIG. 15 depicts a flowchart diagram showing one embodiment of a method 1500 for managing a checkout process. As shown in FIG. 15, the pre-sale information receiver 702 receives 1502 pre-sale information from a prospective buyer. The pre-sale information may include information to complete a later sale, such as payment information. In one embodiment, the pre-sale information includes shipping information for the prospective buyer. In some embodiments, the pre-sale information is collected as part of a registration process. In one embodiment, the prospective buyer may include more than one payment method.

In some embodiments, the purchase request receiver 704 receives 1504 a purchase request from the prospective buyer. The purchase request may be triggered by the prospective buyer selecting or clicking an option on a screen associated with the product. In response to receiving the purchase request, the confirmation generator 706 generates a purchase confirmation option that is presented 1506 to the prospective buyer for a predetermined time. The purchase confirmation option may include a selectable option that the prospective buyer can select or click to confirm intent to purchase the product. In some embodiments, the purchase confirmation option may include additional options, such as selection for a payment method from among a plurality of payment methods received by the pre-sale information receiver 702.

The confirmation receiver 708 determines 1508 if a purchase confirmation is received from the prospective buyer within the predetermined time. If the confirmation receiver 708 receives the confirmation from the prospective buyer within the predetermined time, the sale processor 710 processes 1510 the sale and assigns the sale to a seller. If the confirmation receiver 708 does not receive the confirmation from the prospective buyer within the predetermined time, the confirmation receiver does not accept a purchase confirmation from the prospective buyer and the purchase confirmation option is closed 1512.

FIG. 16 is a diagram of one embodiment of a computer system 1600 for facilitating the execution of the commerce manager 108. Within the computer system 1600 is a set of instructions for causing the machine to perform any one or more of the methodologies discussed herein. In alternative embodiments, the machine may be connected (e.g., networked) to other machines in a LAN, an intranet, an extranet, or the Internet. The machine can be a host in a cloud, a cloud provider system, a cloud controller or any other machine. The machine can operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1600 includes a processing device 1602, a main memory 1604 (e.g., read-only memory (ROM), flash memory, dynamic random access memory (DRAM) such as synchronous DRAM (SDRAM) or DRAM (RDRAM), etc.), a static memory 1606 (e.g., flash memory, static random access memory (SRAM), etc.), and a secondary memory 1618 (e.g., a data storage device in the form of a drive unit, which may include fixed or removable computer-readable storage medium), which communicate with each other via a bus 1630.

Processing device 1602 represents one or more general-purpose processing devices such as a microprocessor, central processing unit, or the like. More particularly, the processing device 1602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1602 may also be one or more special-purpose processing devices such as an application specific integrated circuit (ASIC), a field programmable gate array (FPGA), a digital signal processor (DSP), network processor, or the like. Processing device 1602 is configured to execute the instructions 1626 for performing the operations and steps discussed herein.

The computer system 1600 may further include a network interface device 1622. The computer system 600 also may include a video display unit 1610 (e.g., a liquid crystal display (LCD) or a cathode ray tube (CRT)) connected to the computer system through a graphics port and graphics chipset, an alphanumeric input device 1612 (e.g., a keyboard), a cursor control device 1614 (e.g., a mouse), and a signal generation device 1620 (e.g., a speaker).

The secondary memory 1618 may include a machine-readable storage medium (or more specifically a computer-readable storage medium) 1624 on which is stored one or more sets of instructions 1626 embodying any one or more of the methodologies or functions described herein. In one embodiment, the instructions 1626 include instructions for the commerce manager 108. The instructions 1626 may also reside, completely or at least partially, within the main memory 1604 and/or within the processing device 1602 during execution thereof by the computer system 1600, the main memory 1604 and the processing device 1602 also constituting machine-readable storage media.

The computer-readable storage medium 1624 may also be used to store the instructions 1626 persistently. While the computer-readable storage medium 1624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The instructions 1626, components and other features described herein can be implemented as discrete hardware components or integrated in the functionality of hardware components such as ASICS, FPGAs, DSPs or similar devices. In addition, the instructions 1626 can be implemented as firmware or functional circuitry within hardware devices. Further, the instructions 1626 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “providing,” “generating,” “installing,” “monitoring,” “enforcing,” “receiving,” “logging,” “intercepting,” “computing,” “calculating,” “determining,” “presenting,” “processing,” “confirming,” “publishing,” “receiving,” “applying,” “detecting,” “selecting,” “updating,” “assigning,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. In addition, unless specifically stated otherwise as apparent from the following discussion, it is appreciated that throughout the description, discussions utilizing terms such as “manager,” “receiver,” “generator,” “tracker,” “biaser,” “calculator,” “associator,” detector,” “publisher,” or the like, refer to processes operating on a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for managing dynamic pricing for online sales, the system comprising:
a server to operate a commerce manager;
wherein the server comprises:
a processing device; and
a memory;
wherein the commerce manager comprises:
a dynamic price manager operating on the processing device of the server to dynamically generate a price for a product, the dynamic price manager influenced by market cues, the price generated at a predetermined time interval; and
a client to interact with the commerce manager, the client in communication with the server via a network, wherein the client displays the price.

2. The system of claim 1, wherein the commerce manager further comprises a demand variable generator to generate a demand variable for the product, wherein:
the demand variable generator receives a demand parameter;
the demand variable is computationally produced using the demand parameter;
the demand parameter is weighted by a predetermined demand parameter weight;
the demand variable is generated at a predetermined time interval;
the demand parameter reflects information from a predetermined window of time; and
the demand variable is used as a market cue by the dynamic price manager.

3. The system of claim 2, wherein the demand parameter is selected from the group consisting of sale history, sale price, and social reach.

4. The system of claim 2, wherein the demand variable generator comprises a social reach tracker to generate a social reach parameter, the social reach parameter to indicate a magnitude of social reach of a prospective buyer.

5. The system of claim 4, wherein the social reach tracker comprises:
an account associator to access a social network account of the prospective buyer;
a link detector to determine if the prospective buyer has requested publication of information about an item offered for sale by the system;
a reach detector to detect the magnitude of the reach of the prospective buyer on the social network; and
a social reach parameter generator to generate a social reach parameter in response to information from the reach detector.

6. The system of claim 1, wherein the commerce manager further comprises a supply variable generator to generate a supply variable for the product, wherein:
the supply variable generator receives a supply parameter;
the supply variable is computationally produced using the supply parameter the supply parameter is weighted by a predetermined supply parameter weight;
the supply variable is generated at a predetermined time interval;
the supply parameter reflects information from a predetermined window of time; and
the supply variable is used as a market cue by the dynamic price manager.

7. The system of claim 6, wherein the supply parameter is selected from the group consisting of amount of available product and contract price of available product.

8. The system of claim 1, wherein the commerce manager further comprises a price history display manager to display a graph showing historical prices for a product over a predetermined period of time.

9. The system of claim 1, wherein the commerce manager further comprises a seller queue manager to order a plurality of sellers of a product.

10. The system of claim 1, wherein the commerce manager further comprises a bank manager to allocate a portion of profits from one or more previous sales to a prospective sale, wherein the dynamic price manager generates a reduced price in response to the allocation of profits from the bank manager.

11. The system of claim 1, wherein the product comprises a physical product.

12. A method of managing dynamic pricing for a product, the method comprising:
computing a demand variable for a product in response to a demand parameter, wherein:
the demand parameter is weighted by a predetermined demand parameter weight;
the demand variable is generated at a predetermined time interval; and
the demand parameter reflects information from a predetermined window of time;
computing a supply variable for the product in response to a supply parameter, wherein:
the supply parameter is weighted by a predetermined supply parameter weight;
the supply variable is generated at a predetermined time interval; and
the supply parameter reflects information from a predetermined window of time; and
dynamically generating, by a processor, a price for the product in response to the demand parameter and the supply parameter, the price generated at a predetermined time interval.

13. The method of claim 12, further comprising:
receiving a purchase request for the product at the price at the time of the purchase request;
providing a confirmation option to confirm purchase of the product for a predetermined period of time; and
processing the purchase of the product at the price at the time of the purchase request in response to receiving a confirmation within the predetermined period of time.

14. The method of claim 13, wherein the predetermined period of time is between three and thirty seconds.

15. The method of claim 13, wherein the predetermined period of time is between eight and twelve seconds.

16. The method of claim 13, further comprising receiving pre-sale information from a buyer, the pre-sale information comprising payment information.

17. A non-transitory computer readable storage medium including instructions that, when executed by a processing device, cause the processing device to perform a method comprising:
computing a demand variable for a product in response to a demand parameter, wherein:
the demand parameter is weighted by a predetermined demand parameter weight;
the demand variable is generated at a predetermined time interval; and
the demand parameter reflects information from a predetermined window of time;
computing a supply variable for the product in response to a supply parameter, wherein:
the supply parameter is weighted by a predetermined supply parameter weight;
the supply variable is generated at a predetermined time interval; and
the supply parameter reflects information from a predetermined window of time; and
dynamically generating, by a processor, a price for the product in response to the demand parameter and the supply parameter, the price generated at a predetermined time interval.

18. The non-transitory computer readable storage medium of claim 17, wherein the method further comprises:
arranging a plurality of sellers of the product into a seller queue wherein one seller of the plurality of sellers is the first seller in the seller queue;
receiving a purchase confirmation for the product at a purchase price;
determining if the purchase price is greater than or equal to a contract price set by the first seller;
assigning the purchase to the first seller in response to the purchase price being greater than or equal to the contract price set by the first seller; and
in response to the purchase price being less than the contract price set by the first seller, determining if the purchase price is greater than or equal to a contract price set by a second seller in the seller queue and assigning the purchase to the second seller in response to the purchase price being greater than or equal to the contract price set by the second seller.

19. The non-transitory computer readable storage medium of claim 18, wherein the method further comprises reordering the seller queue in response to a purchase being assigned to a seller such that:
in response to the purchase being assigned to the first seller, the first seller is moved down the seller queue and the second seller becomes the first seller for a subsequent purchase; and
in response to the purchase being assigned to the second seller, the first seller remains the first seller and the second seller is moved down the seller queue for a subsequent purchase.

20. The non-transitory computer readable storage medium of claim 18, wherein the order of the seller queue is modified in response to a seller providing a contract price below a predetermined threshold such that the seller is moved to a position above other sellers in the seller queue.
